(19) United States
(12) Patent Application Publication
(10) Pub. No.: US 2005/0024052 A1
(43) Pub. Date: Feb. 3, 2005

(54) Adiabatic radiofrequency pulse schemes for use in performing nuclear magnetic resonance spectroscopy

(76) Inventors: M. Robin Bendall, Santa Cruz, CA (US); Lance J. DelaBarre, St. Anthony, MN (US); Michael Garwood, Maple Plain, MN (US)

Correspondence Address: M. Robin Bendall, 83 S. Branciforte Avenue, Santa Cruz, CA, 95062, US

(21) Appl. No.: 10/882,554

(22) Filed: Jun. 30, 2004

Related U.S. Application Data
(60) Provisional application No. 60/484,575, filed on Jul. 1, 2003.

(51) Int. Cl. G01V 3/00

(52) U.S. Cl. 324/307; 324/309

(57) ABSTRACT

Adiabatic radiofrequency (RF) pulses are commonly used in nuclear magnetic resonance spectroscopy and imaging. Adiabatic half passage (AHP) pulses show increased non-ideal behavior with respect to adiabatic full passage pulses. The invention is a method of analysis of the initial and final states existing at the beginning and end of an AHP pulse which shows that this non-ideal behavior arises from these initial and final states. In a first embodiment of the invention, a method is obtained to allow forward AHP pulses to be used as selective RF pulses in selective NMR spectroscopy. In a second embodiment of the invention, a method called “an amplitude ramp” is added to an AHP pulse to increase the effective bandwidth of the AHP pulse. In a third embodiment of the invention, a method called “a frequency offset ramp” is added to an AHP pulse to eliminate Gibbs truncation artifacts generated by the truncation of the RF amplitude modulation function used in the AHP pulse. In a fourth embodiment, a time delay is added asymmetrically to four consecutive AHP pulses (also known as a BIR-4 scheme) to produce a chemical shift correlation sub-sequence of RF pulses for use in multi-dimensional NMR.

### BACKGROUND OF THE INVENTION

The context of the present work can best be described as a conventional NMR (nuclear magnetic resonance) system. Such a conventional system is described in U.S. Pat. No. 4,742,303 incorporated herein by reference. The invention concerns methods for improving AHP (adiabatic half passage) RF (radiofrequency) pulses for use in various types of NMR experiments. The terminology used in this disclosure is as commonly used in the NMR literature and examples may be found in the publications cited.

AFP (adiabatic full passage) RF pulses have been used widely in NMR spectroscopy and imaging (also known as magnetic resonance imaging or MRI) for almost two decades and this has resulted in numerous scientific publications. For the earliest references see Silver, Joseph, Chen, Sank and Hoult (Nature, 310, 681 (1984)) and Baum, Tycko and Pines (Physical Review A, 32, 3435 (1985)). AFP pulses are inversion or 180° pulses. All such pulses are amplitude and frequency modulated. The RF amplitude begins at or near zero, increases to a maximum at the middle of the pulse and then decreases symmetrically to zero at the end of the pulse. The RF begins at a frequency offset relative to the frequency of the nuclear spins. The magnitude of this offset decreases to zero at the center of the pulse, and then increases symmetrically but with opposite sign for the second half of the pulse. Thus, the second half of the pulse is a mirror image in time of the first half except that the sign of the frequency offset changes at the middle of the pulse.

During the pulse the nuclear spins are perturbed by an effective magnetic field, Bₑ, which is a function of the RF amplitude (B₁) and the RF offset (ΔH) such that its magnitude is given by
Bₑ=(B₁²+ΔH²)^{0.5}. [1]
The orientation of nuclear spins during NMR experiments is commonly described relative to a frame of reference rotating with the nuclear spins, with the net magnetization of the spins, M, along the z axis at equilibrium. In this rotating reference frame, Bₑ is aligned with or close to the z axis at the beginning of the AFP pulse, and rotates continuously away from the z axis during the first half of the pulse and is coincident with the xy plane at the middle of the pulse. During the second half of the AFP pulse Bₑ continues to rotate so that it becomes aligned closely with the −z axis at the end of the pulse. The angle, a, that Bₑ makes with the xy plane is given by
tan a=ΔH/B₁. [2]
Provided that the rotation of Bₑ is not too rapid, the net magnetization, M, rotates with Bₑ during the AFP pulse and thus inverts with Bₑ.

The initial sign of the frequency offset, ΔH, may be negative so that Bₑ rotates from −z to z instead of z to −z as just described. In this alternative case, M is aligned with the Bₑ axis but points in the opposite direction. During the AFP pulse this alignment is retained so that M is still rotated from z to −z in the same manner as for an initial positive value of ΔH.

The criterion that the rotation of Bₑ should not be too rapid is known as the adiabatic condition and is commonly expressed as
|da/dt|<<Bₑ. [3]
If the rotation of Bₑ is too rapid, or Bₑ is not quite aligned with ±z axis at the beginning of the AFP pulse, then M becomes or is misaligned with Bₑ and M will tend to precess around Bₑ as Bₑ rotates. Commonly, this misalignment increases during the first half of the AFP pulse and is maximum at the middle of the pulse, but then decreases in an approximate mirror image during the second half of the pulse so that M nevertheless undergoes an almost perfect 180° inversion. Thus, AFP pulses are somewhat insensitive to these types of imperfections.

Some RF pulses in NMR methods are 180° pulses and so AFP pulses can be used in these instances. However, more commonly, the constituent RF pulses induce 90° rotations of the net magnetization, M, of the nuclear spins. Adiabatic 90° RF pulses are either the first half or the second half of an adiabatic full passage (AFP) pulse, hence the name, adiabatic half passage (AHP). Accordingly, Eqs. [1] to [3] also apply to AHP pulses. For convenience we will call the first half of an AFP pulse a “forward” AHP pulse and the second half of an AFP pulse a “reverse” AHP pulse. Whereas AFP pulses are inversion pulses, forward AHP pulses are excitation pulses, yielding transverse (x or y) magnetization from initial z-axis magnetization and reverse AHP pulses may be used to transform transverse magnetization back to the z axis.

As noted above, non-ideal behavior of an AFP pulse is commonly worst at the middle of the pulse. Since an AHP pulse terminates or commences at a point equivalent to the middle of an AFP pulse, AHP pulses are commonly found to be much more sensitive than AFP pulses to the effects of non-alignment of M with Bₑ.

The first description of an AHP NMR pulse was provided by Bendall and Pegg (Journal of Magnetic Resonance, 67, 376 (1986) and U.S. Pat. No. 4,820,983 (1989)). Although this invention came soon after the first equivalent AFP work, the additional sensitivity of AHP pulses, over AFP pulses, has limited the application of AHP pulses in NMR spectroscopy and imaging. The problem mentioned in the preceding paragraph is only one example of the cause of the additional sensitivity of AHP pulses to non-ideal behavior. The embodiments of the invention overcome aspects of this non-ideal behavior that is generated more readily by AHP pulses in contrast to AFP pulses.

Conventionally, the RF pulses used in NMR spectroscopy are simple rectangular pulses—the RF amplitude is increased from zero rapidly, maintained at a constant level for the entire pulse length, and then switched off rapidly so that the envelope of the amplitude is rectangular and the frequency is also constant during the pulse. However, the effect of conventional rectangular RF pulses on the nuclear spins is sensitive to missetting of the pulse amplitude and to variation of this amplitude (RF inhomogeneity) throughout the NMR sample. Thus the application of conventional RF pulse sequences requires careful and frequent calibration of the RF amplitude. In contrast, above a limiting value of the maximum amplitude (RFₘₐₓ) during adiabatic pulses (the limit is determined by the adiabatic condition [3]), all AFP and AHP pulses are insensitive to inhomogeneity or miscalibration of the RF amplitude. In simple terms, M remains aligned with Bₑ throughout the adiabatic pulse, and for an AFP pulse, for example, Bₑ rotates from z to −z, irrespective of whether the amplitude of the pulse is increased above the limiting value of RFₘₐₓ.

Because of this insensitivity to RF inhomogeneity or miscalibration, adiabatic RF pulses have significant advantages when used in automated NMR methods, where there is a reduced opportunity to precisely calibrate the RF amplitude. All the embodiments of the invention have been reduced to practice for implementation in automated NMR spectroscopy.

During the last two decades it has been usual to develop the theory of adiabatic pulses in terms of their amplitude and frequency modulation functions. For example, see Tesiram and Bendall (Journal of Magnetic Resonance, 156, 26 (2002)). However, frequency modulation is not usually available on commercial NMR spectrometers. Instead, since phase is the integral of frequency, the frequency modulation is commonly implemented as an equivalent phase modulation. In this disclosure we will also develop the theoretical bases of all embodiments of the invention in terms of frequency modulation but reduction to practice normally utilizes phase modulation.

### BRIEF DESCRIPTION OF THE INVENTION

The development of adiabatic pulses over the last two decades has mostly been concerned with the nature of their amplitude/frequency modulation functions and the combined behavior of these functions in generating a rotating effective field, Bₑ, that complies with the adiabatic condition, [3]. For example, see Tesiram and Bendall (Journal of Magnetic Resonance, 156, 26 (2002)) for analyses of the sech/tanh and tanh/tan modulation functions. Such work has mostly concentrated on AFP pulses.

The embodiments of the invention overcome aspects of the non-ideal behavior that is generated more readily by AHP pulses in contrast to AFP pulses. In general, the invention is a method of analysis of the initial and final states existing at the beginning and end of an AHP pulse which shows that this non-ideal behavior arises from these initial and final states. The second and third embodiments of the invention add to, or modify, known amplitude/frequency modulation functions to ameliorate the effects of this non-ideal behavior. The first and fourth embodiments use two or more AHP pulses, to suppress this non-ideal behavior and produce useful NMR methods.

In a first embodiment of the invention, a method is obtained to allow forward AHP pulses to be used as selective RF pulses in selective NMR spectroscopy. This method has significant advantages over the use of selective AFP pulses.

In a second embodiment of the invention, a method called “an amplitude ramp” is added to the end of a forward AHP pulse or the beginning of a reverse AHP pulse to increase the alignment of the effective field, Bₑ, with the xy plane of the nuclear spin rotating frame of reference and thus increase the effective bandwidth of the AHP pulse.

In a third embodiment of the invention, a method called “a frequency offset ramp” is added to the beginning of a forward AHP pulse or the end of a reverse AHP pulse to ensure alignment of the effective field, Bₑ, with the ±z axes of the nuclear spin rotating frame of reference. This method eliminates Gibbs truncation artifacts or wobbles generated by the truncation of the RF amplitude modulation function.

In a fourth embodiment, a time delay is added asymmetrically to four consecutive AHP pulses (also known as a BIR-4 scheme) to produce a chemical shift correlation subsequence of RF pulses for use in multi-dimensional NMR.

### BRIEF DESCRIPTION OF THE DRAWINGS

TABLE 1 lists the amount of signal obtained using three different methods of employing adiabatic pulses to select individual nuclear spins in a NMR spectrum. The two sets of results are for two different nuclear spins having different T₁ relaxation times.

FIG. 1 graphs the dependence of the transverse component of the net magnetization, M_{xy}, versus the frequency offset, s, for several values of RFₘₐₓ for nuclear spins aligned with a tilted effective field, Bₑ, at the end of a forward AHP RF pulse.

FIG. 2 shows the results of calculations for selective AHP pulses. In a, the frequency sweep of an AHP(+) pulse begins at +bwdth/2=7.5 Hz and ends at zero frequency offset, whereas in b the sweep begins at −bwdth/2=7.5 Hz for a AHP(−) pulse and ends at zero. A selected bandwidth of 15 Hz is obtained in c by subtracting a from b.

FIG. 3 provides ¹H NMR spectra of a sample of 1% sucrose. Part of the normal spectrum is shown in b obtained using a broadband lorentzian/OIA AHP pulse. The selected spectrum in a was acquired using selective lorentzian/OIA AHP pulses.

### THE EFFECTIVE MAGNETIC FIELD AT THE END OF AN AHP PULSE

In terms of general normalized amplitude and frequency modulation functions, F₁(τ) and F₂(τ), that yield values between 0 and 1, the RF amplitude (B₁) and the RF offset (ΔH) can be written generally for various adiabatic pulses as
B₁=RFₘₐₓF₁(τ) [4]
ΔH=(bwdth/2) [±F₂(τ)+s], [5]
where τ=t/Tₚ for a forward AHP pulse, τ=1−t/Tₚ for a reverse AHP pulse, and time t increases from 0 at the beginning of the pulse to Tₚ, the pulse length, at the end of the pulse. RFₘₐₓ is the maximum RF amplitude. bwdth/2 is the initial frequency offset of a forward AHP pulse and the final offset of a reverse AHP pulse. The ± sign in Eq. [5] indicates that the frequency sweep may commence at + or −bwdth/2.

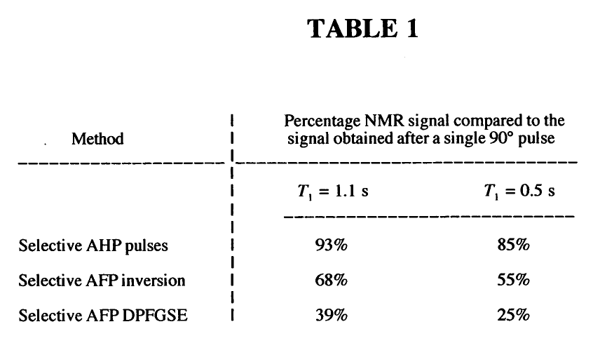

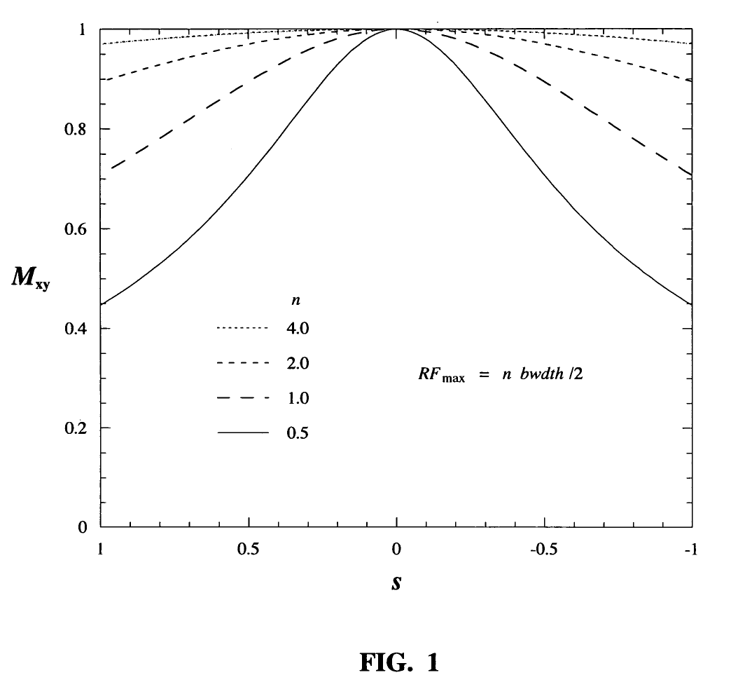

s is a dimensionless offset term corresponding to nuclear spins offset from the RF frequency at the end of a forward AHP pulse or from the RF frequency at the beginning of a reverse AHP pulse. At the end of a forward AHP pulse, the net magnetization, M, of spins that are offset by s will be aligned with an effective field, Bₑ, that is tilted away from the xy plane by an angle a given by
tan a=(bwdth s)/(2 RFₘₐₓ). [6]
Thus, offset spins cannot undergo an ideal 90° pulse and instead the required transverse component of M, M_{xy}, is given by cos a, so that
M_{xy}=cos (tan⁻¹ [(bwdth s)/(2 RFₘₐₓ)]), [7]
and this dependence is plotted in FIG. 1. The same problem arises at the beginning of a reverse AHP pulse.

This problem inherent to AHP pulses is not found for AFP pulses. The value of s does affect the performance of an AFP pulse via the adiabatic condition but this effect is modest. Provided the RF amplitude is large and |s|<<1, the tilt of the effective field at the middle of the AFP pulse, given by Eq. [6], has little overall effect. Bₑ and the nuclear spins merely rotate through the xy plane before or after the middle of the pulse but are still inverted at the end of the pulse.

Solutions to this limitation, arising at the end of a forward AHP pulse or at the beginning of a reverse AHP pulse, are incorporated into the first and second embodiment of the invention.

### SELECTIVE AHP PULSES FOR USE IN SELECTIVE NMR SPECTROSCOPY

Many types of AFP pulses produce a rectangular inversion profile (often called a “top-hat” inversion profile) and are thus naturally selective. For example, see Tesiram and Bendall (Journal of Magnetic Resonance, 156, 26 (2002)) for analyses of the sech/tanh AFP pulse (selective) and the tanh/tan AFP pulse (not selective). The frequency sweep of an AFP pulse begins at ΔH=+bwdth/2 and ends at ΔH=−bwdth/2. If the rate of the frequency sweep is slow at the beginning and end of the pulse (eg. sech/tanh), the AFP pulse is selective and the edges of the inversion profile corresponding to 50% inversion occur at ±bwdth/2 (ie. |s|=1). In this case the nuclear spin magnetization, M, and the effective field, Bₑ, invert for all values of |s| just less than one. If the frequency sweep is rapid at the beginning and end of the pulse (eg. tanh/tan), the AFP pulse is non-selective and only a small fraction of bwdth is inverted completely—the pulse is effective only for |s| values that are much less than one.

Theoretically, selective AFP pulses can be used instead of conventional amplitude modulated 180° pulses for selective inversion in selective NMR spectroscopy. However we have already noted above that an AFP pulse can be considered to be the combination of a forward AHP pulse (first half) and a reverse AHP pulse (second half). The first half establishes the right-hand side of the selected region at +bwdth/2, and the second half produces the left-hand side edge of the selected region at −bwdth/2. In contrast, a conventional amplitude modulated pulse establishes both sides of the selected region simultaneously, since there is no frequency sweep to distinguish one side from the other. Accordingly, it is found that an AFP pulse is always at least twice as long as an equivalent conventional pulse. Selective pulses are necessarily long and so NMR signal is lost via relaxation during these long pulses. Thus, doubling the length by using AFP pulses doubles the loss of signal and results in a significant disadvantage.

There are two main methods for using selective 180° pulses in selective NMR spectroscopy. In the first inversion method, the selective 180° pulse is included in the NMR pulse sequence for every odd NMR transient to invert magnetization that is along the z axis, M_{z}. The pulse is omitted for every even transient and the NMR signals from odd and even transients are subtracted—to a first approximation all NMR signals are canceled by the subtraction except those arising from the nuclear spins that are selectively inverted for odd transients. Unfortunately, the 180° inversion pulse perturbs the non-inverted spins to a small extent so that they are not perfectly canceled by the subtraction, thus degrading the selectivity.

The second major inversion method is the Double Pulsed Field Gradient Spin Echo (DPFGSE) method of Hwang and Shaka (Journal of Magnetic Resonance A, 112, 275 (1995)). In this DPFGSE method the selective 180° pulse is applied twice to transverse M_{xy} magnetization with each pulse nested between two pulsed field gradients to yield a spin echo that is only refocused for the inverted nuclear spins. The method retains the selectivity of the inversion pulses perfectly, but if selective AFP pulses are used there is a further loss of signal via relaxation since two AFP pulses must be employed.

The disadvantages of using selective AFP pulses in selective NMR spectroscopy are overcome by the first embodiment of the invention in which AHP excitation pulses rather than AFP inversion pulses are used to obtain the frequency selectivity.

This embodiment of the invention comprises the use of two AHP pulses that are identical except that their frequency sweeps are mirror images. For the first AHP pulse, labelled AHP(+), the frequency sweep begins at offset, ΔH=+bwdth/2, and reduces to zero. For the second AHP pulse, labelled AHP(−), the frequency sweep begins at offset, ΔH=−bwdth/2, and increases to zero. Generally, any two-dimensional NMR method can be converted to a one-dimensional selective NMR method by substituting these AHP(+−) pulses for a 90° excitation pulse in the two-dimensional NMR pulse sequence. The only additional requirement is that AHP(+) is substituted for odd NMR transients and AHP(−) is substituted for even transients, or vice versa, and the signals for odd and even transients are subtracted.

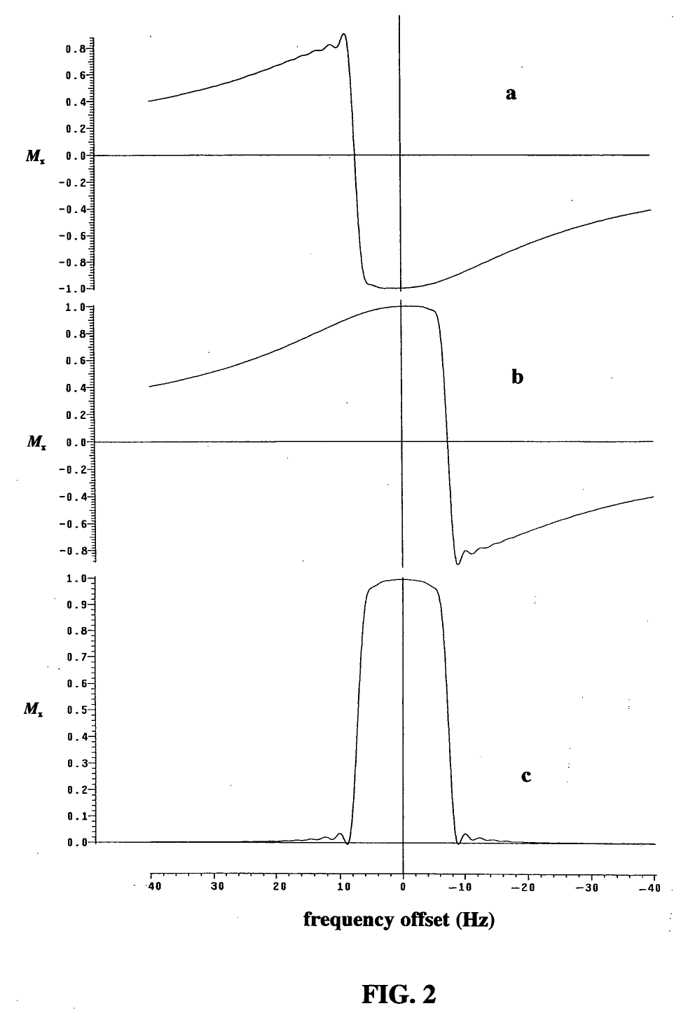

This embodiment of the invention is generated by the analysis of both the initial and final states of a forward AHP pulse, illustrated by the results of typical AHP(+) and AHP(−) pulses shown in FIGS. 2a and b respectively for bwdth=15 Hz.

For the purposes of illustration it is assumed that the final phase of the AHP pulse corresponds to the x axis (or zero phase) of the nuclear spin rotating frame of reference (accomplished as described in the later section, “REDUCTION TO PRACTICE”). Thus, during the AHP pulses the effective field, Bₑ, rotates from the ±z to the x axis. FIG. 2 graphs the x component, Mₓ, of the initial net magnetization, M, after the AHP pulses. The near-vertical discontinuities in FIGS. 2a and b correspond to the frequency offsets of the initial frequency sweep at ±bwdth/2. For spins having frequencies to the left of the discontinuities (s>1), the offset ΔH is always positive. Thus, Bₑ begins along the z axis aligned with M and rotates down towards the x axis producing a +Mₓ component. Alternatively, for nuclear spins having frequencies to the right of the discontinuities (s<−1), the offset ΔH is always negative. For these spins, Bₑ begins along the −z axis aligned in the opposite direction to M and rotates up towards the x axis producing a −Mₓ component.

The curvature away from Mₓ=±1, obvious in FIGS. 2a and 2b to the left and right of zero frequency offset, results from the final state of these forward AHP pulses and is caused by the final tilt of Bₑ away from the x axis as described above in the section, “THE EFFECTIVE MAGNETIC FIELD AT THE END OF AN AHP PULSE”, and illustrated in FIG. 1.

Subtraction of the results in FIG. 2a from those in FIG. 2b yields the excellent top-hat selectivity profile shown in FIG. 2c. Accordingly, FIG. 2 illustrates the necessary requirements of the first embodiment of the invention.

The selectivity profile in FIG. 2c is similar to the inversion profile that is obtained from an AFP pulse that is the combination of the forward AHP(+) and a reverse AHP(−) pulse. Thus the selectivity of the AHP method is the same as that provided by an AFP pulse that is twice the length of each AHP.

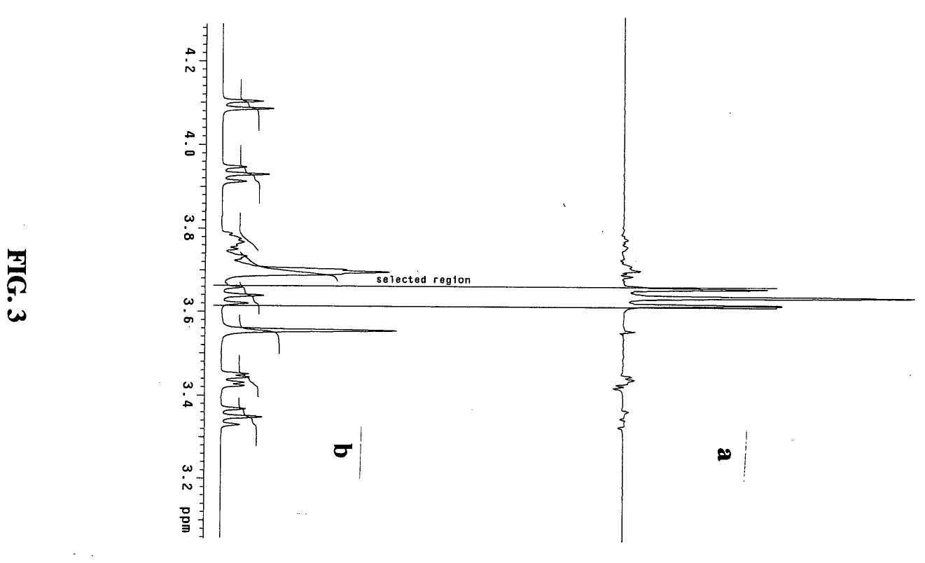

Various amplitude/frequency modulation functions may be used to obtain results similar to those shown in FIG. 2. However, to obtain sharp discontinuities as in FIGS. 2a and 2b, and thus good top-hat selectivity, the frequency sweep must be slow at the beginning of these forward AHP(+−) pulses. Thus, for example, as described above, sech/tanh functions would be suitable but tanh/tan modulation would provide poor selectivity. The particular results in FIG. 2 and FIG. 3a utilize lorentzian/OIA functions (Tₚ=0.5s) with tanh(5τ)-smoothed truncation as described in the later sections, “AMPLITUDE RAMP AT THE END OF A FORWARD AHP PULSE” and “ELIMINATION OF TRUNCATION ARTIFACTS”.

To improve the method it is often helpful to destroy any M_{y} or M_{z} magnetization components after the AHP(+−) pulses. This may be achieved by using a broadband 90° pulse (written as 90° in Scheme [8] below) to interconvert Mₓ and M_{z}, followed by a pulsed field gradient (written as G in [8]) to destroy M_{xy}, followed by a second 90° pulse to return the Mₓ initially present after the AHP(+−) pulses as in
AHP(+−); 90°; G; 90° [8]
Scheme [8] may be used in place of any excitation pulse in a two-dimensional NMR method to produce a selective one-dimensional NMR technique. Typical results of the use of Scheme [8] to select a ¹H multiplet are shown in FIG. 3a, compared to the normal non-selected spectrum in FIG. 3b. The NMR sample used to obtain the FIG. 3 results was 1% sucrose in D₂O solvent. The amplitude scale for 3a has been increased eight times compared to 3b. The small signals just to the left and right of the selected triplet in 3a arise because the selectivity profile is not perfect. The other small signals are mostly produced via TOCSY transfer from the selected nuclear spins during the long selective pulses—these are usually naturally suppressed for all one-dimensional methods except in 1D-TOCSY spectra where they do not matter.

There are three main advantages for the use of AHP(+−) pulses instead of AFP pulses in selective NMR spectroscopy and thus three main advantages for this embodiment of the invention.

First, this embodiment of the invention is analogous to the first AFP inversion method described above in that both methods require the subtraction of the NMR signals from odd and even NMR transients. However, the AHP(+) and AHP(−) pulses are almost identical and so perturb non-selected nuclear spins in a similar manner for odd and even transients, thus providing excellent cancellation of these unwanted NMR signals in contrast to the first AFP inversion method. Furthermore, nuclear spins that have a large offset from the frequencies of the selected bandwidth are only weakly excited by the AHP(+−) pulses. This is a result of Bₑ tipping only slightly during the RF pulses as introduced for FIG. 1 and further illustrated by the curvature towards Mₓ=0 for large offsets as in FIGS. 2a and 2b. Accordingly, spins at large offsets are excluded with additional efficiently by this secondary effect.

Second, each AHP(+−) pulse only establishes the selectivity on one side of the overall top-hat region. Thus these AHP(+−) pulses are half the length of an AFP pulse with the same selectivity, thus reducing the loss of signal via NMR relaxation during the long selective pulses.

Third, if Scheme [8] is used as the first excitation pulse in an NMR pulse sequence an additional NMR signal advantage accrues. The magnetization of nuclear spins that relax via T₁ processes during an AHP pulse is returned to the z axis and then it is substantially rotated down to the x axis by the remainder of the AHP pulse, so regaining most of the otherwise lost NMR signal. There is a modest cost in terms of selectivity. For example, spins that relax halfway through the AHP pulse would have their selectivity reduced by a factor of two—for this context we may define selectivity as the reciprocal slope of the sides of the selected top-hat region. However, since less signal can be excited during the second half of the pulse than during the first half, the average loss of selectivity must always be less than a factor of two even for very rapid relaxation.

An illustration of the third advantage is shown in TABLE 1. The percentage results represent the amount of NMR signal acquired relative to the signal obtained after a single broadband 90° pulse as in the spectrum shown in FIG. 3b. The NMR sample was 1% sucrose in D₂O solvent. The T₁=1.1 s column is for the CH doublet at 5.3 ppm (not shown in FIG. 3b) and the T₁=0.5 s column corresponds to the CH₂ singlet at 3.55 ppm in FIG. 3b. The total length of the AFP pulses were 400 ms compared to 500 ms for the AHP pulses so that for these results the AHP method provides at least twice as much selectivity as the AFP methods even after allowing for the loss of selectivity via T₁ relaxation as described in the preceding paragraph. In addition to this advantage it is clear that the AFP methods lose a considerable fraction of NMR signal via relaxation during the selective pulses compared to the AHP method. (The loss for the AFP inversion method is only half as bad as for the AFP DPFGSE method because the lossy AFP inversion pulse is only used for half the NMR transients in the inversion method).

### AMPLITUDE RAMP AT THE END OF A FORWARD AHP PULSE

As described in the section, THE EFFECTIVE MAGNETIC FIELD AT THE END OF AN AHP PULSE, the effective field (Bₑ) at the end of a forward AHP pulse is tilted away from the xy plane of the nuclear spin reference frame for spins that are offset (|s|>0) from the final frequency of the AHP pulse. Since the spins are adiabatically aligned with Bₑ, some z magnetization (M_{z}) will remain and M_{xy} will be less than ideal for a broadband AHP pulse. This is illustrated in FIG. 1. A mirror image problem arises at the beginning of a reverse AHP pulse.

An analysis of this final state for a forward AHP pulse leads to the second embodiment of the invention, the addition of a rapid increase in amplitude (B₁) at the end of a forward AHP pulse or the beginning of a reverse AHP pulse, which we will call an “amplitude ramp”. This increase in B₁ decreases the tilt of Bₑ away from the xy plane for |s|>0, thus increasing M_{xy} as plotted in FIG. 1 and so increasing the effective bandwidth of a broadband AHP pulse. A necessary requirement is that this reduction in the tilt of Bₑ must be achieved adiabatically.

The adiabatic condition from Eq. [3] can be rearranged using Eqs. [4] to [6] as
|da/dt|/Bₑ=|B₁dΔH/dt−ΔH dB₁/dt|/(B₁²+ΔH²)^{1.5}<<1. [9]
For an amplitude ramp at constant frequency for spins offset at S=s (bwdth/2), this reduces to
|da/dt|/Bₑ=|S dB₁/dt|/(B₁²+S²)^{1.5}<<1. [10]
To minimize |da/dt|/Bₑ during the amplitude ramp, this quantity should be a constant. Since typically the spin offset, S, is small compared to B₁ at the end of a broadband AHP pulse, this would require that |dB₁/dt|/B₁³=constant. But, this is mathematically impossible, so there is no analytical solution leading to an ideal amplitude ramp function.

However, it is possible to eliminate bad amplitude ramp functions. For example, the additional increase in RF amplitude at the end of a forward AHP pulse could be delivered as a power function in time as
B₁=RFₘₐₓ(1+[m−1]τ^{p}), [11]
where m RFₘₐₓ is the final value of B₁, τ is a normalized time function increasing from 0 to 1 during the ramp, and p is the power. For p=1, a linear amplitude ramp, values of |da/dt|/Bₑ from Eq. [10] for typical values S and RFₘₐₓ are maximum at the beginning of the ramp decreasing to zero at the end of the ramp. For p=2 (quadratic) or 3 (cubic), the maximum occurs part way through the ramp and is less than half that of the linear ramp. This maximum shifts towards the end of the ramp and increases for larger powers since there is little increase in B₁ at the beginning of the ramp and the final portion of the ramp becomes steeper for larger p values. Thus a quadratic or cubic increase in B₁ is optimum.

Since Bₑ is already large at the end of a forward AHP pulse, the amplitude can be ramped up quickly so that the length of the ramp is less than one third of the length of the initial AHP pulse. Indeed, for widely differing AHP pulses such as sech/tanh and tanh/tan, the amplitude ramp can be inserted into the last one third of the pulse rather than appended to the end of the initial pulse. When added in this way, the performance for spins at zero offset (s=0) can be retained by increasing the length of the overall pulse by less than 10% and the performance for non-zero offsets (|s|>0) is increased in agreement with the smaller tilt for the final increased value of Bₑ. This insertion method is generally more efficient because the overall pulse length is less and less total RF power is delivered to the NMR sample.

The successful insertion of a quadratic amplitude ramp into the last one third of a forward sech/tanh AHP pulse leads to a variation of this embodiment of the invention. The combined amplitude function increases more steeply than the original sech function and has similarities to a lorentzian function. This leads to the conclusion that there should be single analytic functions such as lorentzian that function efficiently for AHP pulses because the RF amplitude increases steeply at the end of a forward pulse. However, the rate of this increase is limited by the adiabatic condition as exemplified by the loss of efficiency for large p values when using the power function of Eq. [11].

Accordingly, a number of analytic amplitude functions were analyzed. In order of increasing steepness at the end of a forward AHP pulse, these were the well known mathematical functions: hyperbolic tangent (tanh); sine; hyperbolic secant (sech); lorentzian; and (lorentzian)^{0.5}. Also a double-reciprocal-linear (DRlin) function was analyzed for which the amplitude function for use in place of Eq. [4] is given by
1/B₁=(1/RFₘₐₓ)([b+1]/τ−b). [12]
The tanh, sech, lorentzian and (lorentzian)^{0.5} functions were truncated at the 1% level for the purposes of the comparison. The steepness of DRlin increases with increasing values of the parameter b, and DRlin(b=100) provides a similar shape to 1%-truncated (lorentzian)^{0.5}.

The corresponding frequency functions were generated in each case by the Offset-Independent-Adiabaticity (OIA) method of Tannus and Garwood (Journal of Magnetic Resonance A, 120, 133 (1996)). This method attempts to make the adiabaticity condition of Eq. [9] constant across the effective bandwidth of the pulse and the resulting theorem is that the best frequency function, F₂(τ) of Eq. [5], can be derived from the starting amplitude function, F₁(τ) of Eq. [4], by
F₂(τ)=∫[F₁(τ)]²dt. [13]
The F₂(τ) formulae are usually not simple mathematical functions so we will label the resulting amplitude/frequency pairs as amplitude/OIA pairs except for the sech amplitude function, which yields the well known sech/tanh pair via Eq. [13].

For the comparison it was assumed that RFₘₐₓ>=20 kHz and M_{xy} after the forward AHP pulse should be more than 0.98 of the initial M_{z} across an effective bandwidth of 8 kHz. The analysis showed that the lorentzian/OIA AHP pulse provides the shortest pulse length for the least total RF power delivered to the sample. The less steep amplitude functions required greater total RF power. Steeper functions such as (lorentzian)^{0.5} fail in comparison because of loss of adiabaticity at the end of a forward AHP pulse—they have an advantage if RFₘₐₓ is doubled for the same effective bandwidth. These findings are in agreement with the discussion concerning the amplitude ramp of Eq. [11].

### ELIMINATION OF TRUNCATION ARTIFACTS

The most useful amplitude functions for adiabatic pulses are often mathematical functions that require truncation (e.g. sech and lorentzian) since they only return zero values when their arguments are ± infinity. Thus it is common to truncate these functions at the 1% level. However, this results in B₁=0.01 RFₘₐₓ at the beginning of a forward AHP pulse and for spins offset closest to the initial frequency of the AHP pulse (ie. |s| values closest to 1) the initial effective field, Bₑ, will be tilted substantially away from the spins aligned with the z axis of the nuclear spin reference frame. The third embodiment of the invention yields methods to reduce this truncation problem by aligning the initial effective field with the ±z axis.

One method is to multiply the amplitude function of Eq. [4] by tanh(m τ), or a similar function, where m typically takes values of 3-5 units. This smoothly increases B₁ from zero independently of the F₁ function used, but does not greatly change the overall nature of the F₁ function. Increasing m decreases the initial fraction of a forward AHP pulse, or the final fraction of a reverse AHP pulse, over which the smoothing tanh function operates.

A second method is to add a “frequency offset ramp” at the beginning of a forward AHP pulse or equivalently at the end of a reverse AHP pulse. For a forward AHP pulse, the added frequency offset ramp begins at a large offset and rapidly reduces to zero. The large initial value increases the tilt angle a in Eq. [6] to close to 90° by replacing bwdth/2 by a much larger value for all nuclear spins. The underlying theory is similar to that provided above for the amplitude ramp. For a frequency ramp the condition equivalent to Eq. [10] at small and constant B₁ is
|da/dt|/Bₑ=|B₁dΔH/dt|/ΔH³<<1, [14]
and a ramp that is a decreasing power function in time, analogous to Eq. [11], can be devised. For the amplitude ramp the available RFₘₐₓ is limited by the RF amplifier available on the NMR spectrometer that is being used, and the maximum RF heating that the NMR sample can withstand. There are no such limitations for the RF frequency offset so the initial offset can be very large. This method was implemented using a frequency ramp, inserted into the first one third of a AHP pulse, given by
ΔH₁=(bwdth/2)3m(p+1)(1−3τ)^{p}, [15]
where τ takes values of 0 to 0.333 during the ramp. As described in the next section, frequency modulation is usually implemented as a phase modulation, where phase is the integral of frequency, so Eq. [15] was implemented more simply as an additional phase ramp given in degrees by
phase=360Tₚ(bwdth/2)m(1−3τ)^{p+1}. [16]

A frequency offset ramp according to Eq. [15] was added to the lorentzian/OIA pulse. For the conditions described in the last paragraph of the preceding section, optimum values were m=0.2 and p=11. The large power value of 11 shows that a large initial frequency offset can be decreased very rapidly close to the beginning of the forward AHP pulse without compromising adiabaticity.

The discontinuity produced by the truncation of amplitude functions yields Gibbs truncation artifacts, or “wobbles”, in the final value of M_{xy} across the effective bandwidth of an AHP pulse. This is confusing since similar wobbles are also produced if adiabaticity is insufficient (Eq. [9]). Elimination of the truncation wobbles by either of the methods introduced above permits a more conclusive examination of the adiabatic efficiency of the pulse. Thus, a repeat of the comparison of the analytic amplitude functions described in the preceding section, shows improvements for all the truncated amplitude pulses when the truncation is smoothed. It also permits the nature of the pulse to be varied by increasing the initial truncation factor above the nominal 1% value and this also allows modest gains in AHP efficiency. However a repeat of the comparison of the various amplitude functions, with these improvements implemented, does not change the overall conclusions of the preceding section.

For broadband AHP pulses, a direct comparison of the two methods of smoothing the truncation discontinuity shows that the effective bandwidth is usually improved modestly for the frequency ramp method over the tanh(m τ) multiplication method. The spectrum in FIG. 3b was obtained with a lorentzian/OIA AHP pulse smoothed with a frequency offset ramp. However, the selectivity of selective AHP pulses is destroyed by a frequency offset ramp, since the top-hat edge of the selected bandwidth is established by a frequency sweep that is initially very slow, so the tanh(m τ) multiplication method must be used in these cases. The spectrum in FIG. 3a was obtained with selective lorentzian/OIA AHP(+−) pulses smoothed by multiplying the lorentzian amplitude function by tanh(5τ).

### ASYMMETRIC BIR-4 METHODS

Garwood and Ugurbil (U.S. Pat. No. 5,019,784 (1991)) have described a BIR-4 (B₁ Independent Rotation-4) method that achieves plane rotations using symmetrical adiabatic or composite RF pulses. In this context, “plane rotation” means the rotation of a plane of spins around a fixed axis, for example the rotation of the xz plane around the y axis.

Using the concepts introduced in the section, BACKGROUND OF THE INVENTION, the BIR-4 method can be considered to be a combination of four 90° degree rotations, and thus four consecutive AHP pulses, written as
rAHP; fAHP; rAHP; fAHP, [17]
where fAHP is a forward AHP pulse and rAHP is a reverse AHP pulse. The BIR-4 method described by Garwood and Ugurbil also required a phase shift of φ₁=180°+θ/2 for the second and third of the four AHP pulses, relative to the first AHP pulse. The phase is shifted back to that of the first AHP for the fourth AHP using a shift of φ₂=−180°−θ/2. The overall BIR-4, implemented in this way, yields a plane rotation of θ degrees about a chosen axis in the transverse xy plane determined by the basic phase of all four AHP pulses. We have found the 180° term in φ₁ and φ₂ to be redundant, or in general the shift of the second and third AHP pulses relative to the first and fourth is n180°+θ/2, so we will write the general BIR-4 method as
rAHP; fAHP[n180°+θ/2]; rAHP[n180°+θ/2]; fAHP, [18]
where n is any integer including zero.

Throughout U.S. Pat. No. 5,019,784, Garwood and Ugurbil used concepts of symmetry to establish their invention—the invention description includes “time symmetric” in the title and all methods claimed are symmetric in time about the midpoint of the implemented method. In U.S. Pat. No. 5,019,784, Garwood and Ugurbil extended their invention to some particular methods of heteronuclear and homonuclear NMR spectral editing by inserting two time delays symmetrically within the BIR-4 scheme, as
rAHP--τ--fAHP[n180°+θ/2]; rAHP[n180°+θ/2]--τ--fAHP, [19]
where τ is the time delay. These are called BISEP methods in U.S. Pat. No. 5,019,784.

In a fourth embodiment of the invention we teach that it is effective and useful in some circumstances to introduce a time delay that is asymmetric with respect to the midpoint of the BIR-4 method.

Over the last three decades, hundreds of multi-dimensional NMR methods of spectral analysis have been developed. In general these are known as two-dimensional (2D), three-dimensional (3D), four-dimensional (4D) and methods of even higher dimensionality. Each method comprises a particular sequence of RF pulses. At some point in the overall pulse sequence, the vast majority of these methods include a sub-sequence known as a chemical-shift correlation sub-sequence. Examples of such sequences include the most commonly employed homonuclear methods known as COSY, TOCSY, and NOESY, and the most commonly employed heteronuclear methods called HSQC, HMQC and HMBC. The development of these methods, and more complex examples, are described in many hundreds of published works forming a large fraction of the entire present-day NMR literature.

In its simplest form the common chemical-shift correlation sub-sequence is
90°--t₁--90°, [20]
two 90° rectangular RF pulses separated by a variable or incremented t₁ time delay. The first 90° pulse rotates a set of NMR spin vectors from the longitudinal ±z axes to the transverse ±x or ±y axes, depending on the phase of the 90° pulse. During the intermediate t₁ delay these spins effectively rotate in the xy plane at the chemical shift difference between their characteristic NMR frequency and the RF pulse frequency. Thus, the x or y vector components of these transverse spins are modulated sinusoidally as a function of the length of the t₁ delay. Depending on the phase of the second 90° pulse, either the ±x or the ±y components are transferred back to the ±z axes by this second 90° pulse. Accordingly, the sinusoidal modulation as a function of t₁ is also transferred back to the ±z axes and this modulation is subsequently detected as a modulation of the detected NMR signal, as a function of t₁, after completion of the entire sequence of RF pulses. Suitable signal processing, commonly Fourier transformation with respect to t₁, then permits the display of the chemical shift difference frequencies, operable during t₁, as one dimension of the final multi-dimensional spectrum.

The fourth embodiment of the invention is to add an incremented t₁ time asymmetrically to a BIR-4 scheme as
rAHP--t₁--fAHP[n180°+θ/2]; rAHP[n180°+θ/2]; fAHP, [21]
or alternatively as
rAHP; fAHP[n180°+θ/2]; rAHP[n180°+θ/2]--t₁--fAHP. [22]
If θ=0 then either scheme [21] or [22] achieves the same outcome as the conventional scheme [20] except that the advantages of using adiabatic pulses instead of rectangular pulses accrue.

An explanation for this new invention can again be found by analyzing the initial and final states before and after each AHP pulse in the BIR-4 scheme.

For example, after the first AHP pulse in scheme [17] (a reverse AHP), the spins that were initially along the z axis are spread out in the xy plane in a non-ideal fashion depending on their frequency offset. The second and third AHP pulses refocus this divergence of the spins so that they become aligned with the x axis (if the RF phase of the reverse and forward AHP pulses is chosen to begin and end, respectively, along the x axis). The fourth AHP pulse, also initially aligned with this x axis, then rotates the spins back to the z axis yielding an overall zero pulse. However, if a t₁ time delay is added before the fourth AHP pulse as in scheme [22], the x vector component becomes sinusoidally modulated as a function of t₁ and this modulation is transferred to the ±z axes by the fourth AHP pulse. Alternatively, if scheme [21] is employed, the t₁ modulation added after the first AHP pulse is not refocused by the second and third AHP pulses, and is again transferred to the ±z axes.

Further detailed analysis of the initial and final states before and after each AHP pulse shows that the general n180°+θ/2 phase shift in the general BIR-4 scheme [18] merely shifts the phase of the final modulation along the ±z axes by θ degrees. Thus schemes [21] and [22] are equivalent to a modification of the rectangular pulse scheme [20] written as
90°--t₁--90°[θ]. [23]
This θ phase shift is not generally helpful, so it may as well be set to zero. Schemes [21] and [22], for use as chemical shift correlation sub-sequences thus simplify to
rAHP--t₁--fAHP; rAHP; fAHP, [24]
and
rAHP; fAHP; rAHP--t₁--fAHP. [25]

A common improvement used for the sub-sequence scheme [20] is to alternate the phase of one of the rectangular 90° pulses between 0 and 180° (or +x and −x) on alternate NMR transients, which we will write as
90°[±x]--t₁--90°, [26]
or
90°--t₁--90°[±x]. [27]
This alternates the phase of the spins along the ±z axes after the subsequence and thus alternates the sign of the final detected NMR signal. Accordingly, subtraction of the NMR signal from alternate transients sums the required signal. This phase alternation method is commonly used to suppress signal artifacts. It is easily shown that this same alternation may be added to schemes [24] and [25] as
rAHP[±x]--t₁--fAHP; rAHP; fAHP, [28]
and
rAHP; fAHP; rAHP--t₁--fAHP[±x]. [29]
Thus schemes [24], [25], [28] and [29] may substitute as the adiabatic equivalents of the conventional chemical shift correlation sub-sequences commonly used in NMR spectroscopy.

### REDUCTION TO PRACTICE

The vast majority of NMR spectrometers cannot deliver the amplitude/frequency modulated RF as an exact analogue waveform, but instead the RF is digitized into short increments of constant amplitude and frequency. The well known requirement that ensures that the digitized waveforms are of sufficient accuracy is that the length of each increment must be short compared to the reciprocal of the width of the final spectrum.

In addition, most spectrometers are unable to modulate the RF frequency but can instead modulate the RF phase, which is the integral of the RF frequency modulation. Thus, to implement the forward AHP pulses described above, the F₂ frequency functions are integrated to determine the equivalent phase functions as

$${F}_{3} ( t ) = 2 π {\int }_{0}^{{T}_{p}} {F}_{2} ( t / {T}_{p} ) ⅆ t . \qquad [ 17 ]$$

The resulting analytical formulae for phase do not necessarily yield a zero phase at the end of a forward AHP pulse. To convert M_{z} to pure Mₓ, where the x axis represents zero phase, the phase function must be F₃(t)−F₃(Tₚ) radians, and for pure M_{y} it should be F₃(t)−F₃(Tₚ)+π/2 radians. The integral of F₂(1−t/Tₚ) may be obtained to determine the phase function of a reverse AHP pulse, but it is equivalent to run the phase function for the forward pulse in reverse for reverse AHP pulses.

Some commercial spectrometers are unable to modulate the RF amplitude. However, AHP RF pulses may still be delivered to the NMR sample using the method of Bodenhausen, Freeman and Morris (Journal of magnetic Resonance, 23, 171 (1976)) that is now well known as the DANTE method. In the DANTE method, a pulse increment, length=tᵢ, with a modulated RF amplitude of B₁, is equivalently delivered to the sample as a shorter increment, length=tᵢB₁/RFₘₐₓ, at a constant amplitude of RFₘₐₓ followed by a delay, length=tᵢ (1−B₁/RFₘₐₓ).

On such spectrometers with limited hardware it is also often the case that it is not possible to change the phase quickly enough between pulse increments to achieve the necessary phase modulation function. Normally, however, rapid phase changes are possible between the quadrature phases, 0° (or 360°), 90°, 180° and 270°. Thus, a pulse increment, length=tᵢB₁/RFₘₐₓ, with a phase of h° can be delivered as two shorter increments, at the quadrature phases that lie either side of h°, given by (h/90 modulo 4) 90°, and [(h/90 modulo 4)+1] 90°. The lengths of the two quadrature pulse increments must be such that they sum vectorially to yield the replaced h° increment and so they are of length tᵢ₁=cos [h−(h/90 modulo 4) 90] tᵢ B₁/RFₘₐₓ and tᵢ₂=sin [h−(h/90 modulo 4) 90] tᵢ B₁/RFₘₐₓ, respectively, where the arguments to the sine and cosine functions are in degrees. For B₁ values close to RFₘₐₓ, it is possible that tᵢ₁+tᵢ₂>tᵢ, which is not permissible. This problem may be overcome by delivering the increments at an increased constant RF amplitude of 2^{0.5} RFₘₐₓ and reducing tᵢ₁ and tᵢ₂ by the same factor of 2^{0.5}. But generally the maximum RF amplitude is limited, so this solution has disadvantages. Noting that the problem will only potentially arise for a small fraction of the pulse length at the end of a forward AHP pulse, a good approximation is to reduce both tᵢ₁ and tᵢ₂ by the factor (tᵢ₁+tᵢ₂)/tᵢ whenever tᵢ₁+tᵢ₂>tᵢ. This more convenient solution to the problem generally results in a negligible loss of performance of the AHP pulse.

All methods of implementing AHP pulses on NMR spectrometers, including the methods described in this section, are included within the scope of the invention.

While the invention has been particularly shown and described with reference to preferred embodiments thereof, it will be understood by those skilled in the art that the foregoing and other changes in form and details may be made therein without departing from the spirit and scope of the invention.

1. The method of operating a nuclear magnetic resonance spectrometer in relation to a sample containing at least a first group and a second group of nuclear spins,
said first group having a nuclear spin frequency f₁ and said second group having a nuclear spin frequency f₂,
to achieve selective excitation of the first group,
said method comprising
a) applying a first radiofrequency pulse sequence to induce a first detected signal transient, the first pulse of said first sequence being a first forward adiabatic half passage pulse;
b) applying a second radiofrequency pulse sequence to induce a second detected signal transient, the first pulse of said second sequence being a second forward adiabatic half passage pulse;
c) said first forward adiabatic half passage pulse having an initial frequency of f₃+d and a final frequency of f₃, wherein d is a frequency offset that is less than the difference between said frequency f₃ and said frequency f₂;
d) said second forward adiabatic half passage pulse being identical to said first forward adiabatic half passage pulse except by having an initial frequency of f₃−d;
e) said frequency f₃ being close to said frequency f₁ so that frequency f₁ is within the frequency range bounded by said frequency f₃+d and said frequency f₃−d;
e) subtracting the said first detected signal transient from the said second detected signal transient.

2. The method according to claim 1 comprising repeating the method for multiples of the said first and second detected signal transients.

3. The method according to claim 1 comprising changing from the said initial frequencies to the said final frequencies by modulating the phase of the radiofrequency of the said adiabatic pulses.

4. The method of operating a nuclear magnetic resonance spectrometer in relation to a sample containing nuclear spins, said method comprising
a) applying a radiofrequency pulse sequence wherein at least one pulse is a forward adiabatic half passage pulse;
b) said forward adiabatic half passage pulse terminating with a radiofrequency amplitude ramp wherein the said amplitude increases to a maximum, said increase being rapid in comparison to prior increases of said amplitude during the pulse and said increase complying with the adiabatic condition for adiabatic radiofrequency pulses.

5. The method according to claim 4 comprising replacing the said forward adiabatic half passage pulse with its time-reversed equivalent, a reverse adiabatic half passage pulse.

6. The method according to claim 4 wherein the said radiofrequency amplitude is an analytical lorentzian function of time.

7. The method according to claim 4 wherein the said radiofrequency amplitude is an analytical function of time F₁(τ) and the corresponding analytical frequency function for the said adiabatic pulse is given by the mathematical formula F₂(τ)=∫[F₁(τ)]²dt.

8. The method according to claim 6 wherein the said radiofrequency amplitude is an analytical function of time F₁(τ) and the corresponding analytical frequency function for the said adiabatic pulse is given by the mathematical formula F₂(τ)=∫[F₁(τ)]²dt.

9. The method of operating a nuclear magnetic resonance spectrometer in relation to a sample containing nuclear spins, said method comprising
a) applying a radiofrequency pulse sequence wherein at least one pulse is a forward adiabatic half passage pulse;
b) said forward adiabatic half passage pulse beginning with a radiofrequency frequency offset ramp wherein the said frequency offset initially decreases, said initial decrease being rapid in comparison to subsequent decreases of said frequency offset during the pulse and said initial decrease complying with the adiabatic condition for adiabatic radiofrequency pulses.

10. The method according to claim 9 comprising replacing the said forward adiabatic half passage pulse with its time-reversed equivalent, a reverse adiabatic half passage pulse.

11. The method according to claim 9 wherein the said frequency offset ramp is a time-reversed power function of time wherein the said power is an integer greater than five.

12. The method according to claim 9 wherein the said adiabatic half passage pulse comprises a radiofrequency amplitude function that is an analytical lorentzian function of time F₁(τ), and a corresponding analytical frequency function given by the sum of the mathematical formula F₂(τ)=∫[F₁(τ)]²dt and the said frequency offset ramp.

13. The method according to claim 11 wherein the said adiabatic half passage pulse comprises a radiofrequency amplitude function that is an analytical lorentzian function of time F₁(τ), and a corresponding analytical frequency function given by the sum of the mathematical formula F₂(τ)=∫[F₁(τ)]²dt and the said frequency offset ramp.

14. The method of operating a nuclear magnetic resonance spectrometer in relation to a sample containing nuclear spins, said method comprising applying a radiofrequency pulse sequence wherein at least four of the pulses are an asymmetric BIR-4 scheme,
said asymmetric BIR-4 scheme comprising
a) consecutively applying a first reverse adiabatic half passage pulse, a first forward adiabatic half passage pulse, a second reverse adiabatic half passage pulse, and a second forward adiabatic half passage pulse, wherein all four of the said adiabatic pulses comprise the same radiofrequency amplitude and frequency modulations;
b) asymmetrically inserting a time delay after the said first reverse adiabatic half passage pulse or after the said second reverse adiabatic half passage pulse;
c) detecting a signal from the said nuclear spins.

15. The method according to claim 14 comprising
a) incrementing the said time delay;
b) Fourier transforming the said detected signal with respect to the said time delay.

16. The method according to claim 14 comprising
a) alternating the phase, between 0° and 180°, of either the said first reverse adiabatic half passage pulse or of the said second forward adiabatic half passage pulse between successive applications of the said radiofrequency pulse sequence;
b) alternatively adding and subtracting the said detected signal produced by successive applications of the said radiofrequency pulse sequence.

17. The method according to claim 14 comprising adding a phase shift to the said first forward adiabatic half passage pulse and the said second reverse adiabatic half passage pulse.
